(19) United States
(12) Patent Application Publication
(10) Pub. No.: US 2024/0294828 A1
(43) Pub. Date: Sep. 5, 2024

(54) USE OF SILICATES IN A GREENHOUSE FILM FOR INCREASING FRUIT DEVELOPMENT OF PLANTS

(71) Applicant: Solvay SA, Brussels (BE)

(72) Inventors: Morgane Pellerin, Creil (FR); Denis Belekian, Lyon (FR); Franck Aurissergues, Argenteuil (FR); Lauriane D'Alencon, Issy-Les-Moulineaux (FR); Thierry Le Mercier, Rosny-Sous-Bois (FR)

(73) Assignee: Solvay SA, Brussels (BE)

(21) Appl. No.: 17/768,119

(22) PCT Filed: Oct. 12, 2020
(86) PCT No.: PCT/EP2020/078662

§ 371 Date: Apr. 11, 2022

(30) Foreign Application Priority Data
Oct. 11, 2019 (EP) 19306336.9

(51) Int. Cl. C09K 11/77; A01G 9/14; C08J 5/18; C08K 3/34; C09K 11/02

(52) U.S. Cl. CPC C09K 11/77342; A01G 9/1438; C08J 5/18; C08K 3/34; C09K 11/02; C08J 2323/08; C08K 2003/343; C08K 2201/005

(57) ABSTRACT

The present invention relates to the use of silicates in a greenhouse film for increasing the fruit development of a plant, wherein the film comprises at least a matrix and a silicate. Said invention also refers to a film comprising at least a matrix and said silicate to increase the fruit development of a plant, and the use of a film comprising at least a matrix and said silicate in a greenhouse to increase the fruit development of a plant.

The present invention relates to the use of silicates in a greenhouse film for increasing the fruit development of a plant, wherein the film comprises at least a matrix and a silicate. Said invention also refers to a film comprising at least a matrix and said silicate to increase the fruit development of a plant, and the use of a film comprising at least a matrix and said silicate in a greenhouse to increase the fruit development of a plant.

### PRIOR ART

With the increase of the worldwide population, there is a continuous need for providing improved compositions for agriculture needs. Such agrochemical compositions should be efficient in terms of promoting plant growth and increasing crop yields. There is therefore a general desire to obtain a high plant productivity. To improve said productivity, organic products have been used quite heavily to increase crop productivity but concerns have been raised about the long-term effects of these products on mammals, especially on humans. There is a therefore also a need for improving the productivity of crops with the help of a product without any concerns about the long-term effects of said product.

Plant growth, usually defined as promoting, increasing or improving the rate of growth of the plant or increasing or promoting an increase in the size of the plant, is nevertheless not the sole factor with respect to the plant development to reach its maturity. Beyond its biomass increase there is also a need to ensure a proper development of fruits; i.e. number of fruits produced by the plants, their sizes and/or quality. Indeed fresh fruit and vegetables are perishable living products that require coordinated activity by growers, storage operators, processors and retailers to maintain size and quality, notably to reduce food loss and waste. The Food and Agriculture Organization estimated that 32% (weight basis) of all food produced in the world was lost or wasted in 2009. When converted into calories, global losses represent approximately 24% of all food produced. Increasing the quality and reducing the loss and waste of fresh fruits and vegetable is important because these foods provide essential nutrients and represent sources of domestic and international revenue.

The sustainability of agriculture demands that production per unit area of land be increased in a cost-effective manner. It has long been the goal of growers to be able to manipulate the vegetative in order to try to increase the quantity and quality of fruits. Total yield of fruits is affected by many factors. For instance, fruit quantity is dependent on flower number and the number of branches capable of bearing flowers, while fruit size is dependent on the number of fruit set. Fruit size is also influenced by the number of leaves exporting the products of photosynthesis to the fruit. Root, tuber and bulb crops are similarly affected by the number of leaves exporting photosynthate to the below ground portions of the plant. Above and below ground parts of the plant produce hormones that further affect production of fruits. Root development, nutrient uptake, water availability, climate and stress (abiotic and biotic) all affect photosynthesis and plant metabolism and hence fruit size. Additionally, all aspects of production are affected by agricultural practices such as pruning, fertilization, irrigation and use of nutritional supplements and plant growth regulators.

At the present time, plant growth regulators (PGRs) are one of the most powerful tools available for manipulating the fruit development. For a wide variety of annual, biennial and perennial crops, PGRs have been used to solve production problems. For example, PGRs have been used successfully as foliar sprays to increase flowering, synchronize bloom, or change the time of flowering to avoid adverse climatic conditions or to shift harvest to a time when the market is more economically favorable. Surprisingly, these successes have been achieved with a modest number of commercial PGRs that are members of or impact the synthesis of one of five classic groups: auxins, cytokinins, gibberellins, abscisic acid and ethylene.

However, as many PGRs are synthetic chemical compounds that mimic the effects of natural plant hormones, they are subject to various regulations and are not favorably received by a growing segment of consumers who prefer organic produce. As such, what the art needs are compositions and methods that employ natural compounds to increase fruits production.

Furthermore, fresh produce attributes such as appearance, texture, flavour and nutritional value, have been traditional quality criteria, but increasingly safety (chemical, toxicological and microbial) and traceability are important for all the role players along the supply chain, from the farm to consumers.

### INVENTION

The present invention aims at solving this technical problem and non-addressed issues. Indeed, it appears that an agrochemical composition not in direct contact with the plants and having a radiation-induced emission efficiency exhibits excellent results in development of fruits, such as the number of fruits produced by the plants, their sizes and/or quality. Then it appears that now it is possible to set a plant treatment permitting to increase the development of fruits without chemicals to affect the natural plant hormones and without any concerns about the long-term effects of said products.

The present invention provides then a treatment of plants which is very effective in terms of increasing the fruit development, and which leads to improved crop yields. Furthermore, the treatment used in the present invention has excellent physicochemical properties and in particular an improved stability on storage. The inorganic nature of the particles has also less impact on environment, in particular reduced long-term effects on mammals, especially on humans.

The present invention then concerns the use of a silicate S1 in a greenhouse film for increasing the fruit development of a plant, wherein the film comprises at least a matrix and a silicate S1, preferably dispersed particles of silicate S1 in the matrix, said silicate S1 exhibiting:

(a) a light emission with a first peak wavelength in the range from 400 nm to 500 nm, preferably from 420 nm to 455 nm, and a second peak wavelength in the range from 550 nm to 700 nm, preferably from 590 nm to 660 nm, and

(b) an absorption inferior or equal to 20%, preferably inferior or equal to 15%, more preferably inferior or equal to 10%, possibly inferior or equal to 5%, at a wavelength greater than 440 nm.

The invention also refers to a film comprising at least a matrix and said silicate S1 to increase the fruit development of a plant, and the use of a film comprising at least a matrix and said silicate S1 in a greenhouse to increase the fruit development of a plant. Such a film and thus the silicate S1 are advantageously used in the manufacture or construction of greenhouses (greenhouse roofs, walls).

It appears that the silicates of the invention permits to the film to convert a solar or artificial radiation, preferably UV radiation, into blue and/or red light especially, or alternatively to convert solar or artificial radiation, preferably UV radiation, and especially solar UV radiation, into lower-energy radiation, allowing then an improvement in the fruit development.

### DETAILED INVENTION

### Definitions

While the following terms are believed to be understood by one of ordinary skill in the art, the following definitions are set forth to facilitate explanation of the presently disclosed subject matter. Unless defined otherwise, all technical and scientific terms used herein have the same meaning as commonly understood by one of ordinary skill in the art to which the presently disclosed subject matter pertains. Although any methods, devices, and materials similar or equivalent to those described herein can be used in the practice or testing of the presently disclosed subject matter, representative methods, device, and materials are now described.

Should the disclosure of any patents, patent applications, and publications which are incorporated herein by reference conflict with the description of the present application to the extent that it may render a term unclear, the present description shall take precedence.

Throughout this specification, unless the context requires otherwise, the word “comprise” or “include”, or variations such as “comprises”, “comprising”, “includes”, “including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

The term “aryl” refers to an aromatic carbocyclic group of 6 to 18 carbon atoms having a single ring (e.g. phenyl) or multiple rings (e.g. biphenyl), or multiple condensed (fused) rings (e.g. naphthyl or anthranyl). Aryl groups may also be fused or bridged with alicyclic or heterocyclic rings that are not aromatic so as to form a polycycle, such as tetralin. The term “aryl” embraces aromatic radicals such as phenyl, naphthyl, tetrahydronaphthyl, indane and biphenyl. An “arylene” group is a divalent analog of an aryl group.

The term “heteroaryl” refers to an aromatic cyclic group having 3 to 10 carbon atoms and having heteroatoms selected from oxygen, nitrogen and sulfur within at least one ring (if there is more than one ring).

The term “aliphatics” refers to substituted or unsubstituted saturated alkyl chain having from 1 to 18 carbon atoms, substituted or unsubstituted alkenyl chain having from 1 to 18 carbon atoms, substituted or unsubstituted alkynyl chain having from 1 to 18 carbon atoms.

As used herein, “alkyl” groups include saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups. The term “aliphatic group” includes organic moieties characterized by straight or branched-chains, typically having between 1 and 18 carbon atoms. In complex structures, the chains may be branched, bridged, or cross-linked. Aliphatic groups include alkyl groups, alkenyl groups, and alkynyl groups.

As used herein, “alkenyl” or “alkenyl group” refers to an aliphatic hydrocarbon radical which can be straight or branched, containing at least one carbon-carbon double bond. Examples of alkenyl groups include, but are not limited to, ethenyl, propenyl, n-butenyl, i-butenyl, 3-methylbut-2-enyl, n-pentenyl, heptenyl, octenyl, decenyl, and the like. The term “alkynyl” refers to straight or branched chain hydrocarbon groups having at least one triple carbon to carbon bond, such as ethynyl.

The term “arylaliphatics” refers to an aryl group covalently linked to an aliphatics, where aryl and aliphatics are defined herein.

The term “cycloaliphatics” refers to carbocyclic groups of from 3 to 20 carbon atoms having a single cyclic ring or multiple condensed rings which may be partially unsaturated, where aryl and aliphatics are defined herein. The term “heterocyclic group” includes closed ring structures analogous to carbocyclic groups in which one or more of the carbon atoms in the ring is an element other than carbon, for example, nitrogen, sulfur, or oxygen. Heterocyclic groups may be saturated or unsaturated.

The term “alkoxy” refers to linear or branched oxy-containing groups each having alkyl portions of one to about twenty-four carbon atoms or, preferably, one to about twelve carbon atoms. Examples of such radicals include methoxy, ethoxy, propoxy, butoxy and tert-butoxy.

As used herein, the terminology “(Cn-Cm)” in reference to an organic group, wherein n and m are each integers, indicates that the group may contain from n carbon atoms to m carbon atoms per group.

The term “plant” as used herein refers to a member of the Plantae Kingdom and includes all stages of the plant life cycle, including without limitation, seeds, and includes all plant parts. Plants according to the present invention may be agricultural and horticultural plants, shrubs, trees and grasses, hereinafter sometimes collectively referred to as plants.

The term “fruit” as used herein is to be understood as meaning anything of economic value that is produced by the plant. It may be for instance botanical fruits, vegetables, culinary vegetables, berries and seeds. In botanic, a fruit is a seed-bearing structure that develops from the ovary of a flowering plant, whereas vegetables are all other plant parts, such as roots, leaves and stems. A botanical fruit results from maturation of one or more flowers, and the gynoecium of the flower(s) forms all or part of the fruit. Vegetables are commonly defined as herbaceous plants such as cabbages, potatoes, beans, turnips and the like which are cultivated for an edible part used as a table vegetable. An edible part of the plant such as seeds, leaves, roots, bulbs and the like are contrasted with fruits. However, tomatoes are botanically considered to be a fruit therefore the term fruit or vegetable for the purposes of this invention disclosure are defined as those plant produced whether vegetable or fruit.

The term “biomass” means the total mass or weight (fresh or dry), at a given time, of a plant tissue, plant tissues, an entire plant, or population of plants. Biomass is usually given as weight per unit area. Increased biomass includes without limitation increased pod biomass, stem biomass, and root biomass.

The term “film” can be used in a generic sense to include film or sheet, a structural element having a geometric configuration as a three-dimensional solid whose thickness (the distance between the plane faces) is small when compared with other characteristic dimensions (in particular length, width) of the film. Films are generally used to separate areas or volumes, to hold items, to act as barriers, or as printable surfaces.

The term “greenhouse” should be understood herein in its broadest sense as covering any type of shelter used for the protection and growth of crops. For example, they may be plastic greenhouses and large plastic tunnels, glass greenhouses, large shelters, semi-forcing tunnels, flat protective sheets, walls, mulching (mulch film), notably as described in the brochure published by the CIPA (Congrès International du Plastique dans l′Agriculture), 65 rue de Prony, Paris, “L′évolution de la plasticulture dans le Monde” by Jean-Pierre Jouët. Greenhouse may also refer to gardening kit and kit of germination.

The term “emission” corresponds to the photons emitted by a luminescent material under an excitation wavelength matching the excitation spectrum of the luminescent material.

The term “peak wavelength” means publicly recognized meaning, in this specification which can comprise both the main peak of an emission/absorption (preferably emission) spectrum having maximum intensity/absorption and side peaks having smaller intensity/absorption than the main peak. The term peak wavelength can be related to a side peak. The term peak wavelength can be related to the main peak having maximum intensity/absorption.

The term “radiation-induced emission efficiency” should also be understood in this connection, i.e. the silicate absorbs radiation in a certain wavelength range and emits radiation in another wavelength range with a certain efficiency.

### Plants

Plants according to the present invention, such as agricultural plant or horticultural plant, may be a monocot or dicot plant, and may be planted for the production of an agricultural or horticultural product, for example grain, food, fiber, etc. The plant may be a cereal plant. The films and uses of the present invention may be applied to virtually any variety of plants and fruits. The plants may be selected from, but not limited to, the following list:
food crops: such as cereals including maize/corn (Zea mays), sorghum (Sorghum spp.), millet (Panicum miliaceum, P. sumatrense), rice (Oryza sativa indica, Oryza sativa japonica), wheat (Triticum sativa), barley (Hordeum vulgare), rye (Secale cereale), triticale (Triticum X Secale), and oats (Avena fatua);
leafy vegetables: such as brassicaceous plants such as cabbages, broccoli, bok choy, rocket; salad greens such as spinach, cress, basil, and lettuce;
fruiting and flowering vegetables: such as avocado, sweet corn, artichokes, curcubits e.g. squash, cucumbers, melons, watermelons, squashes, such as courgettes, pumpkins; solononaceous vegetables/fruits e.g. tomatoes, eggplant, and capsicums;
podded vegetables: such as groundnuts, peas, beans, lentils, chickpea, and okra;
bulbed and stem vegetables: such as asparagus, celery, allium crops e.g garlic, onions, and leeks;
roots and tuberous vegetables: such as carrots, beet, bamboo shoots, cassava, yams, ginger, Jerusalem artichoke, parsnips, radishes, potatoes, sweet potatoes, taro, turnip, and wasabi;
sugar crops: such as sugar beet (Beta vulgaris) and sugar cane (Saccharum officinarum);
crops grown for the production of non-alcoholic beverages and stimulants: such as coffee, black, herbal and green teas, cocoa, and tobacco;
fruit crops: such as true berry fruits (e.g. kiwifruit, grape, currants, gooseberry, guava, feijoa, pomegranate), citrus fruits (e.g. oranges, lemons, limes, grapefruit), epigynous fruits (e.g. bananas, cranberries, blueberries), aggregate fruit (blackberry, raspberry, boysenberry), multiple fruits (e.g. pineapple, fig), stone fruit crops (e.g. apricot, peach, cherry, plum), pip-fruit (e.g. apples, pears) and others such as strawberries, and sunflower seeds;
culinary and medicinal herbs: such as. rosemary, basil, bay laurel, coriander, mint, dill, Hypericum, foxglove, alovera, and rosehips;
crop plants producing spices: such as black pepper, cumin cinnamon, nutmeg, ginger, cloves, saffron, cardamom, mace, paprika, masalas, and star anise;
crops grown for the production of nuts and oils: such as. almonds and walnuts, Brazil nut, cashew nuts, coconuts, chestnut, macadamia nut, pistachio nuts; peanuts, pecan nuts, soybean, cotton, olives, sunflower, sesame, lupin species and brassicaeous crops (e.g. canola/oilseed rape);
crops grown for production of beers, wines and other alcoholic beverages e.g grapes, hops;
edible fungi e.g. white mushrooms, Shiitake and oyster mushrooms;
plants used in pastoral agriculture: such as legumes: Trifolium species, Medicago species, and Lotus species; White clover (T. repens); Red clover (T. pratense); Caucasian clover (T. ambigum); subterranean clover (T. subterraneum); Alfalfa/Lucerne (Medicago sativum); annual medics; barrel medic; black medic; Sainfoin (Onobrychis viciifolia); Birdsfoot trefoil (Lotus corniculatus); Greater Birdsfoot trefoil (Lotus pedunculatus);
forage and amenity grasses: such as temperate grasses such as Lolium species; Festuca species; Agrostis spp., Perennial ryegrass (Lolium perenne); hybrid ryegrass (Lolium hybridum); annual ryegrass (Lolium multiflorum), tall fescue (Festuca arundinacea); meadow fescue (Festuca pratensis); red fescue (Festuca rubra); Festuca ovina; Festuloliums (Lolium X Festuca crosses); Cocksfoot (Dactylis glomerata); Kentucky bluegrass Poa pratensis; Poa palustris; Poa nemoralis; Poa trivialis; Poa compresa; Bromus species; Phalaris (Phleum species); Arrhenatherum elatius; Agropyron species; Avena strigosa; and Setaria italic;
tropical grasses such as: Phalaris species; Brachiaria species; Eragrostis species; Panicum species; Bahai grass (Paspalum notatum); Brachypodium species;
grasses used for biofuel production: such as Switchgrass (Panicum virgatum) and Miscanthus species;
fiber frops: such as hemp, jute, coconut, sisal, flax (Linum spp.), New Zealand flax (Phormium spp.); plantation and natural forest species harvested for paper and engineered wood fiber products such as coniferous and broadleafed forest species;
tree and shrub species used in plantation forestry and bio fuel crops: such as Pine (Pinus species); Fir (Pseudotsuga species); Spruce (Picea species); Cypress (Cupressus species); Wattle (Acacia species); Alder (Alnus species); Oak species (Quercus species); Redwood (Sequoiadendron species); willow (Salix species); birch (Betula species); Cedar (Cedurus species); Ash (Fraxinus species); Larch (Larix species); Eucalyptus species; Bamboo (Bambuseae species) and Poplars (Populus species);
plants grown for conversion to energy, biofuels or industrial products by extractive, biological, physical or biochemical treatment: such as oil-producing plants such as oil palm, jatropha, and linseed;
latex-producing plants: such as the Para Rubber tree, Hevea brasiliensis and the Panama Rubber Tree Castilla elastica;
plants used as direct or indirect feedstocks for the production of biofuels i.e. after chemical, physical (e.g. thermal or catalytic) or biochemical (e.g. enzymatic pre-treatment) or biological (e.g. microbial fermentation) transformation during the production of biofuels, industrial solvents or chemical products e.g. ethanol or butanol, propane diols, or other fuel or industrial material including sugar crops (e.g. beet, sugar cane), starch-producing crops (e.g. C₃ and C₄ cereal crops and tuberous crops), cellulosic crops such as forest trees (e.g. Pines, Eucalypts) and Graminaceous and Poaceous plants such as bamboo, switch grass, miscanthus;
crops used in energy, biofuel or industrial chemical production by gasification and/or microbial or catalytic conversion of the gas to biofuels or other industrial raw materials such as solvents or plastics, with or without the production of biochar (e.g. biomass crops such as coniferous, eucalypt, tropical or broadleaf forest trees, graminaceous and poaceous crops such as bamboo, switch grass, miscanthus, sugar cane, or hemp or softwoods such as poplars, willows;
biomass crops used in the production of biochar;
crops producing natural products useful for the pharmaceutical, agricultural nutraceutical and cosmeceutical industries: such as crops producing pharmaceutical precursors or compounds or nutraceutical and cosmeceutical compounds and materials for example, star anise (shikimic acid), Japanese knotweed (resveratrol), kiwifruit (soluble fiber, proteolytic enzymes);
floricultural, ornamental and amenity plants grown for their aesthetic or environmental properties: such as flowers such as roses, tulips, chrysanthemums;
ornamental shrubs such as Buxus, Hebe, Rosa, Rhododendron, and Hedera;
amenity plants such as Platanus, Choisya, Escallonia, Euphorbia, and Carex;
mosses such as sphagnum moss; and
plants grown for bioremediation: Helianthus, Brassica, Salix, Populus, and Eucalyptus.

Plant species includes but not limited to corn (Zea mays), Brassica sp. (e.g., B. napus, B. rapa, B. juncea), alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Cofea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), tomatoes (Solanum lycopersicum), lettuce (e.g., Lactuca sativa), green beans (Phaseolus vulgaris), lima beans (Phaseolus limensis), peas (Lathyrus spp.), cauliflower (Brassica oleracea), broccoli (Brassica oleracea), turnip (Brassica rapa var. rapa), radish (Raphanus raphanistrum subsp. Sativus), spinach (Spinacia oleracea), cabbage (Brassica oleracea), asparagus (Asparagus officinalis), onion (Allium cepa), garlic (Allium sativum), pepper (Piperaceae), such as Piper nigrum, Piper cubeba, Piper longum, Piper retrofractum, Piper borbonense, and Piper guineense, celery (Apium graveolens), members of the genus Cucumis such as cucumber (Cucumis sativus), cantaloupe (Cucumis cantalupensis), and musk melon (Cucumis melo), oats (Avena sativa), barley (Hordeum vulgare), plants of Cucurbitaceae family such as squash (Cucurbita pepo), pumpkin (Cucurbita maxima) and zucchini (Cucurbita pepo), apple (Malus domestica), pear (Pyrus spp.), quince (Cydonia oblonga), plum (Prunus subg. Prunus), peach (Prunus persica), cherry (such as Prunus avium and Prunus cerasus), nectarine (Prunus persica var. nucipersica), apricot (such as Prunus armeniaca, Prunus brigantina, Prunus mandshurica, Prunus mume, Prunus zhengheensis and Prunus sibirica), strawberry (Fragaria x ananassa), grape (Vitis vinifera), raspberry (plant genus Rubus), blackberry (Rubus ursinus, Rubus laciniatus, Rubus argutus, Rubus armeniacus, Rubus plicatus, Rubus ulmifolius, and Rubus allegheniensis), sorghum (Sorghum bicolor), rapeseed (Brassica napus), clover (Syzygium aromaticum), carrot (Daucus carota), lentils (Lens culinaris), and thale cress (Arabidopsis thaliana).

Mention can further be made of ornamentals species including but not limited to hydrangea (Macrophylla hydrangea), hibiscus (Hibiscus rosasanensis), petunias (Petunia hybrida), roses (Rosa spp.), azalea (Rhododendron spp.), tulips (Tulipa spp.), daffodils (Narcissus spp.), carnation (Dianthus caryophyllus), poinsettia (Euphorbia pulcherrima), and chrysanthemum (Chrysanthemum indicum); and of conifer species including but not limited to conifers pines such as loblolly pine (Pinus taeda), slash pine (Pinus elliotii), ponderosa pine (Pinus ponderosa), lodgepole pine (Pinus contorta), and Monterey pine (Pinus radiata), Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis).

The plants within the contyext of the present invention may notably be a perennial fruit plant, notably selected from the group constituted of: apple, apricot, avocado, citrus (e.g., orange, lemon, grapefruit, tangerine, lime and citron), peach, pear, pecan, pistachio, and plum. Plants in the present invention may notably be an annual crop plant, such as notably selected from the group constituted of: celery, spinach, and tomato.

Preferably, plants are chosen in the group constituted of: tomatoes (Solanum lycopersicum), watermelons (Cucurbitaceae lanatus), peppers, zucchinis, cucumbers, melons, strawberries, blueberries, and raspberries. They are tomatoes for instance.

Specifically, tomatoes classes of interest can be chosen in the group constituted of: long life, grooved, cluster, smooth or salad tomato, cherry and roma tomatoes. Some varieties examples may include: Alicante, Trujillo, Genio, Cocktail, Beefsteak, Marmande, Conquista, Kumato, Adoration, Better Boy, Big Raimbow, Black Krim, Brandwyne, Campari, Canario, Tomkin, Early Girl, Garden peach, Hanover, Jersey Boy, Jubilee, Matt's Wild Cherry, Micro Tom, Montesora, Mortgage Lifter, Plum Tomato, Raf Tomato, Delizia, Roma, San Marzano, Santorini, Super Sweet Tomaccio, Pear Tomato, and Yellow Pear.

### Silicate

Silicate S1 exhibits according to the invention:

(a) a light emission with a first peak wavelength in the range from 400 nm to 500 nm, preferably from 420 nm to 455 nm, and a second peak wavelength in the range from 550 nm to 700 nm, preferably from 590 nm to 660 nm, and (b) an absorption inferior or equal to 15%, preferably inferior or equal to 10%, more preferably inferior or equal to 5%, at a wavelength greater than 440 nm.

Light emission spectrum may be obtained using a Jobin Yvon HORIBA Fluoromax-4+ equipped with a Xenon lamp and 2 monochromators (one for excitation wavelength and one for emission wavelength). The excitation wavelength is fixed at 370 nm and the spectrum is recorded between 390 and 750 nm.

The absorption may be obtained from a diffuse reflection spectrum. Such a spectrum can be recorded using a Jobin Yvon HORIBA Fluoromax-4+ spectrometer equipped with a Xenon lamp and 2 monochromators (one for excitation wavelength and one for emission wavelength) able to work synchronously. With regard to a product, for each given value of wavelength, a reflection (R_{product}) value (intensity) is obtained, which in the end provides a reflection spectrum (R_{product} in function of wavelength). A first reflection (R_{white}) spectrum of BaSO₄ is recorded between 280 nm and 500 nm. BaSO₄ spectrum represents 100% of light reflection (referred to as “white”). A second reflection (R_{black}) spectrum of black carbon is recorded between 280 nm and 500 nm. Black carbon spectrum represents 0% of light reflection (referred to as “black”). The sample reflection (Rₛₐₘₚₗₑ) spectrum is recorded between 280 nm and 500 nm. For each wavelength, the following relationship is calculated: A=1−R, R being equal to (Rₛₐₘₚₗₑ−R_{black})/(R_{white}−R_{black}), i.e. A=(R_{white}−Rₛₐₘₚₗₑ)/(R_{white}−R_{black}), which represents the absorption at each wavelength and which provides the absorption spectrum (in function of wavelength).

Silicate S1 used in the invention may be compounds comprising at least barium, magnesium and silicon. Preferably, in silicate S1, the barium, and the magnesium may be substituted with at least another element, such as for instance: europium, praseodymium and/or manganese.

Silicate S1 may be notably a compound of formula (I):

aMO.a′M′O.bM″O.b′M′″O.cSiO₂ (I)

wherein: M and M″ are selected from the group constituted of: strontium, barium, calcium, zinc, magnesium or a combination of these and M′ and M′″ are selected from the group constituted of: europium, manganese, praseodymium, gadolinium, yttrium with 0.5<a≤3, 0.5<b≤3, 0<a′≤0.5, 0<b′≤0.5 and 1≤c≤2.

Film may comprise, in addition to silicate S1, other types of silicates, such as for instance Ba₂SiO₄ (for example as traces).

Silicate S1 may be notably a compound of formula (II):

aBaO.xEuO.cMgO.yMnO.eSiO₂ (II)

wherein: 0.5<a≤3, 0<x≤0.5, 0<c≤1,0<y≤0.5,1<e≤2.

Preferably a+b+c+d+e is comprised from 90% to 100%, more preferably from 95% to 99%, usually superior or equal to 98 weight %.

formula (II) preferably 0.0001≤x≤0.4 and 0.0001≤y<0.4, more preferably 0.01≤x≤0.35 and 0.04≤y≤0.15.

In the compound of formula (II), the barium, magnesium and silicon may be partially replaced with elements other than those described above. Thus, the barium may be partially replaced with calcium and/or strontium in a proportion that may be up to about 30%, this proportion being expressed by the replacement/(replacement+barium) atomic ratio. The magnesium may be partially replaced with zinc in a proportion that may be up to about 30%, this proportion also being expressed by the Zn/(Zn+Mg) atomic ratio. Finally, the silicon may be partially replaced with germanium, aluminum and/or phosphorus in a proportion that may be up to about 10%, this proportion being expressed by the replacement/(replacement+silicon) atomic ratio.

Whereas a europium-doped barium magnesium silicate emits in the blue range, the presence of manganese as dopant makes it possible to orient the emission of this compound toward the red range. It is possible to adjust the colorimetry of the emission of the additive of the invention by varying the Eu/Mn ratio.

In silicate S1 of formula (II) the barium, the magnesium and the silicon are preferably not substituted with an element other than europium and manganese.

Silicates SI of formula (II) may be chosen in the group constituted of:
Ba_{2.7}Eu_{0.3}Mg_{0.9}Mn_{0.1}Si₂O₈,
Ba_{2.7}Eu_{0.3}Mg_{0.8}Mn_{0.2}Si₂O₈,
Ba_{2.94}Eu_{0.06}Mg_{0.95}Mn_{0.05}Si₂O₈,
Ba_{2.9}Eu_{0.1}Mg_{0.95}Mn_{0.05}Si₂O₈, and
BaMg₂Si₂O₇:Eu, Mn.

Silicate S1 may also correspond to a compound of formula (III):

Ba_{3(1-x-y)}Eu₃ₓPr_{3y}Mg_{1=z}Mn_{z}Si_{2(1-3v/2)}M₃ᵥO₈ (III)

wherein M represents aluminum, gallium or boron and 0<x≤0.3; 0<y≤0,1; 0<z≤0.3; 0≤v≤0,1.

The silicate S1 used for the invention is generally prepared by means of a solid-state reaction at high temperature.

As starting material, it is possible to use directly the metal oxides required or organic or mineral compounds capable of forming these oxides by heating, for instance the carbonates, oxalates, hydroxides, acetates, nitrates or borates of said metals.

An intimate mixture at the appropriate concentrations of all of the starting materials in finely divided form is formed.

It may also be envisioned to prepare a starting mixture by co-precipitation using solutions of the precursors of the desired oxides and/or slurries of oxides, for example in aqueous medium.

The mixture of the starting materials is then heated at least once for a period of between one hour and about one hundred hours, at a temperature of between about 500° C. and about 1600° C.; it is preferable to perform the heating at least partially under a reductive atmosphere, for example hydrogen in argon, to bring the europium totally into divalent form. A flux such as BaF₂, BaCl₂, NH₄Cl, MgF₂, MgCl₂, Li₂B₄O₇, LiF, H₃BO₃, may also be added to the raw material mix before the heating step.

Silicates used in the invention may notably be produced as described in WO2004/044090, WO2004/041963.

It may also be possible to produce silicates of the invention by mixing a silica suspension and starting materials, such as nitrates, followed by a spray drying and calcination, notably calcination by air and/or reduced atmosphere. Such silicates may notably be produced as described in WO2016/001219.

There is no limitation on the form, morphology, particle size or particle size distribution of the silicates thus obtained. These products may be ground, micronized, screened and surface-treated, especially with organic additives, to facilitate their compatibility or dispersion in the application medium.

The particles of silicate S1 are preferably such that the dispersion remains stable over a certain period of time.

Silicate S1 is preferably in the form of solid particles, such as crystallized particles, having a size D50 between 1 μm and 50 μm, more preferably between 2 μm and 10 μm. Silicate S1 may also be in the form of solid particles, such as crystallized particles, having a size D50 between 0.1 μm and 1.0 μm, preferably between 0.1 μm and 0.5 μm.

D50 has the usual meaning used in statistics. D50 corresponds to the median value of the distribution. It represents the particle size such that 50% of the particles are less than or equal to the said size and 50% of the particles are higher than or equal to said size. D50 is determined from a distribution of size of the particles (in volume) obtained with a laser diffraction particle size analyzer. The appliance Malvern Mastersizer 3000 may be used.

### Matrix

According to the present invention, as the matrix material, a transparent photosetting polymer, a thermosetting polymer, a thermoplastic polymer, glass substrates or a combination of any of these, can be used preferably. This matrix may be a natural or non-natural fiber, such as silk, wool, cotton or hemp, or alternatively viscose, nylon, polyamides, polyester and copolymers thereof. The matrix may also be a mineral glass (silicate) or an organic glass. The matrix may also be based on a polymer especially of thermoplastic type. The matrix may comprise at least one polymer or the matrix may be a polymer.

As polymer materials, polyethylene, polypropylene, polystyrene, polymethylpentene, polybutene, butadiene styrene polymer, polyvinyl chloride, polystyrene, polymethacrylic styrene, styrene-acrylonitrile, acrylonitrile-butadiene-styrene, polyethylene terephthalate, polymethyl methacrylate, polyphenylene ether, polyacrylonitrile, polyvinyl alcohol, acrylonitrile polycarbonate, polyvinylidene chloride, polycarbonate, polyamide, polyacetal, polybutylene terephthalate, polytetrafluoroethylene, ethyl vinylacetate copolymer, ethylene butyl acrylate copolymer, ethylene tetrafluorethylen copolymer, phenol polymer, melamine polymer, urea polymer, urethane, epoxy, unsaturated polyester, polyallyl sulfone, polyarylate, hydroxybenzoic acid polyester, polyetherimide, polycyclohexylenedimethylene terephthalate, polyethylene naphthalate, polyester carbonate, polylactic acid, phenolic resin, silicone can be used preferably.

As the photosetting polymer, several kinds of (meth)acrylates can be used preferably. Such as unsubstituted alkyl-(meth)acrylates, for examples, methyl-acrylate, methyl-methacrylate, ethyl-acrylate, ethyl-methacrylate, butyl-acrylate, butyl-methacrylate, 2-ethylhexyl-acrylate, 2-ethylhexyl-methacrylate; substituted alkyl-(meth)acrylates, for examples, hydroxyl-group, epoxy group, or halogen substituted alkyl-(meth)acrylates; cyclopentenyl(meth)acrylate, tetra-hydro furfuryl-(meth)acrylate, benzyl (meth)acrylate, polyethylene-glycol di-(meth)acrylates.

The matrix material may have a Melt Flow Index in the range from 0.1 to 50 g/10 min preferably, notably from 0.1 to 7 g/10 min for polyethylene and from 0.7 to 4 g/min for ethyl vinylacetate copolymer; notably determined using a MFI apparatus, the sample being preheated for 5 min at 190° C., the weight used weights 2.16 kg (according to the standard method ISO1133).

As the thermosetting polymer, publically known transparent thermosetting polymer can be used preferably.

As the thermoplastic polymer, the type of thermoplastic polymer is not particularly limited. For example, natural rubber (refractive index (n)=1.52), poly-isoprene (n=1.52), poly 1,2-butadiene (n=1.50), polyisobutene (n=1.51), polybutene (n=1.51), poly-2-heptyl 1,3-butadine (n=1.50), poly-2-t-butyl-1,3-butadine (n=1.51), poly-1,3-butadine (n=1.52), polyoxyethylene (n=1.46), polyoxypropylene (n=1.45), polyvinylethyl ether (n=1.45), polyvinylhexylether (n=1.46), polyvinylbutylether (n=1.46), polyethers, poly vinyl acetate (n=1.47), poly esters, such as poly vinyl propionate (n=1.47), poly urethane (n=1.5 to 1.6), ethyl cellulose (n=1.48), poly vinyl chloride (n=1.54 to 1.55), poly acrylo nitrile (n=1.52), poly methacrylonitrile (n=1.52), poly-sulfone (n=1.63), poly sulfide (n=1.60), phenoxy resin (n=1.5 to 1.6), polyethylacrylate (n=1.47), poly butyl acrylate (n=1.47), poly-2-ethylhexyl acrylate (n=1.46), poly-t-butyl acrylate (n=1.46), poly-3-ethoxypropylacrylate (n=1.47), polyoxycarbonyl tetra-methacrylate (n=1.47), polymethylacrylate (n=1.47 to 1.48), polyisopropylmethacrylate (n=1.47), polydodecyl methacrylate (n=1.47), polytetradecyl methacrylate (n=1.47), poly-n-propyl methacrylate (n=1.48), poly-3,3,5-trimethylcyclohexyl methacrylate (n=1.48), polyethylmethacrylate (n=1.49), poly-2-nitro-2-methylpropylmethacrylate (n=1.49), poly-1,1-diethylpropylmethacrylate (n=1.49), poly(meth)acrylates, such as polymethylmethacrylate (n=1.49), or a combination of any of these, can be used preferably as desired.

As examples of thermoplastic polymers that are suitable for the invention, mention may be made of: polycarbonates, for instance poly[methanebis(4-phenyl) carbonate], poly[1,1-etherbis(4-phenyl) carbonate], poly[diphenylmethanebis(4-phenyl) carbonate], poly[1,1-cyclohexanebis (4-phenyl) carbonate] and polymers of the same family; polyamides, for instance poly(4-aminobutyric acid), poly(hexamethylene adipamide), poly(6-aminohexanoic acid), poly(m-xylylene adipamide), poly(p-xylylene sebacamide), poly(2,2,2-trimethyl hexamethylene terephthalamide), poly(meta-phenylene isophthalamide), poly(p-phenylene terephthalamide) and polymers of the same family; polyesters, for instance poly(ethylene azelate), poly(ethylene-1,5-naphthalate), poly(1,4-cyclohexanedimethylene terephthalate), poly(ethylene oxybenzoate), poly(para-hydroxybenzoate), poly(1,4-cyclohexylidene dimethylene terephthalate), poly(1,4-cyclohexylidene dimethylene terephthalate), polyethylene terephthalate, polybutylene terephthalate and polymers of the same family; vinyl polymers and copolymers thereof, for instance polyvinyl acetate, polyvinyl alcohol, polyvinyl chloride; polyvinyl butyral, polyvinylidene chloride, ethylene-vinyl acetate copolymers, and polymers of the same family; acrylic-polymers, polyacrylates and copolymers thereof, for instance polyethyl acrylate, poly(n-butyl acrylate), polymethyl methacrylate, polyethyl methacrylate, poly(n-butyl methacrylate), poly(n-propyl methacrylate), and ethylene butyl acrylate copolymer, polyacrylamide, polyacrylonitrile, poly(acrylic acid), ethylene-acrylic acid copolymers, ethylene-vinyl alcohol copolymers, acrylonitrile copolymers, methylstyrene methacrylate copolymers, ethylene-ethyl acrylate copolymers, methacrylate-butadiene-styrene copolymers, ABS, and polymers of the same family; polyolefins, for instance low-density poly(ethylene), poly(propylene) and in general [alpha]-olefins of ethylenes and of propylene copolymerized with other [alpha]-olefins such as 1-butene and 1-hexenes, which may be used at up to 1%. Other comonomers used may be cyclic olefins such as 1,4-hexadiene, cyclopentadiene and ethylidenenorbornene. The copolymers may also be a carboxylic acid such as acrylic acid or methacrylic acid. Finally, mention may be made of low-density chlorinated poly(ethylene), poly(4-methyl-1-pentene), poly(ethylene) and poly(styrene).

Among these thermoplastic polymers, the ones most particularly preferred are polyethylenes and copolymers, including low-density polyethylenes (LDPE), linear low-density polyethylenes (LLDPE), high-density polyethylene (HDPE), polyethylenes obtained via metallocene synthesis, ethyl vinylacetate copolymer (EVA), ethylene butyl acrylate copolymer (EBA), polyvinyl chloride (PVC), polyethylene terephthalate (PET), polymethyl methacrylate (PMMA), (co)polyolefins, polyethylene-vinyl alcohol (EVOH), polycarbonate (PC), and mixtures and copolymers based on these (co)polymers.

### Composition

Composition used in the context of the present invention comprises at least a matrix and the silicate used according to the invention. Silicates SI may be dispersed in the matrix and the film of the invention may comprise a matrix and dispersed particles of silicates in the matrix. Preferably silicates SI may be dispersed in the polymer and the film used in the invention may comprise a polymer and dispersed particles of silicates in the polymer.

The amount of silicate in the film may especially be from 0.01 to 10% by weight particularly from 0.1% to 5% and more particularly from 0.3 to 3% by weight, with respect to the total amount of film. Preferably this amount is equal to 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9 and 2, and any ranges made by these values.

The composition can optionally further comprise one or more of additional inorganic fluorescent materials, notably which emits blue or red light. As an additional inorganic fluorescent material which emits blue or red light, any type of publically known materials, for example as described in the second chapter of Phosphor handbook (Yen, Shinoya, Yamamoto), can be used if desired.

The composition may also comprise other additive(s), for instance stabilizers, plasticizers, flame retardants, dyes, optical brighteners, lubricants, antiblocking agents, matting agents, processing agents, elastomers or elastomeric compositions, for example acrylic copolymers or methacrylate-butadienestyrene copolymers, for improving the flexibility or mechanical strength of the films, adhesion agents, for example polyolefins grafted with maleic anhydride allowing adhesion to polyamide, dispersants allowing better distribution of the silicate in the material or any other additive required for the preparation of a structure of multilayer thermoplastic films, especially those known and often used for making films for greenhouses, for example nondrip or anti-misting additives, or catalysts. This list is not limiting in nature.

Any method for obtaining a dispersion of the silicate in a matrix and especially in a macro-molecular compound of the type such as the above-mentioned polymers, may be used to prepare the compositions and films used according to the invention.

The incorporation of the silicate and optional further components into the polymer may be carried out by known methods such as dry blending in the form of a powder, or wet mixing in the form of solutions, dispersions or suspensions for example in an inert solvent, water or oil. The silicate and optional further additives may be incorporated, for example, before or after molding or also by applying the dissolved or dispersed additive or additive mixture to the polymer material, with or without subsequent evaporation of the solvent or the suspension/dispersion agent. They may be added directly into the processing apparatus (e.g. extruders, internal mixers), e.g. as a dry mixture or powder or as solution or dispersion or suspension or melt.

In particular, a first process consists in mixing the silicate and the other abovementioned additives in a polymer compound in melt form and optionally in subjecting the mixture to high shear, for example in a twin-screw extrusion device, in order to achieve good dispersion. Another process consists in mixing the additive(s) to be dispersed with the monomers in the polymerization medium, and then in performing the polymerization.

Another process consists in mixing with a polymer in melt form, a concentrated blend of a polymer and of dispersed additives (masterbatch), for example prepared according to one of the processes described above. Polymer for the masterbatch and polymer of the matrix may be of the same type or may also be different. The two polymers are preferably compatible so as to form an homogeneous mixture. For instance, when a polymer is an ethylene-vinyl acetate copolymer, the other polymer may be the same ethylene-vinyl acetate copolymer or a different one or may also be a compatible polymer, like for instance a polyethylene. The masterbatch is prepared by the same conventional technique described above, for instance it can be prepared with an extruder. The interest of using a masterbatch is that the particles can be well predispersed using a mixing equipment exhibiting high shear rates. The various additives (e.g. crosslinking agent(s), auxiliary agent(s) described above) may be present in any one of the polymers or may be added separately.

In a process for preparing a composition within the context of the invention, a polymer (polymer 1) and the silicate, or else a polymer (polymer 1) and a masterbatch comprising the silicate pre-dispersed in a polymer (polymer 2), are extruded.

The silicate may be introduced into the synthesis medium for the macromolecular compound, or into a thermoplastic polymer melt in any form. It may be introduced, for example, in the form of a solid powder or in the form of a dispersion in water or in an organic dispersant.

It is also possible to directly disperse the silicate compound in powder form in the matrix, for example by stirring, or alternatively in preparing a powder concentrate in liquid or pasty medium, which is then added to the matrix. The concentrate may be prepared in a water-based or solvent medium, optionally with surfactants, water-soluble or hydrophobic polymers, or alternatively polymers comprising hydrophilic and hydrophobic ends, which may be polar or nonpolar, required for stabilization of the mixture in order to avoid its decantation. There is no limit to the additives that may be included in the composition of the concentrate.

### Film

Greenhouse films within the context of the present invention may be of various shapes such as for instance plates, flat sheet, square, rectangle, circle, walls, tunnel, elliptical, semicircular, shelter, protective sheets and building materials of greenhouse.

The film used according to the invention comprises at least a matrix and a silicate S1, preferably dispersed particles of silicate SI, said silicate S1 exhibiting:

(a) a light emission with a first peak wavelength in the range from 400 nm to 500 nm, preferably from 420 nm to 455 nm, and a second peak wavelength in the range from 550 nm to 700 nm, preferably from 590 nm to 660 nm, and (b) an absorption inferior or equal to 20%, preferably inferior or equal to 15%, more preferably inferior or equal to 10%, possibly inferior or equal to 5%, at a wavelength greater than 440 nm.

The film within the context of the invention may be used as such or may be deposited on or combined with another substrate, such as another film or glass. This deposit or this combination may be prepared by the known methods of coextrusion, lamination and coating for instance. Multilayer structures may be formed from one or more layers of material used according to the invention, combined via layers of coextrusion binder to one or more other layers of one or more thermoplastic polymers, for example polyethylene or polyvinyl chloride, which may constitute a support component, which is predominant in the constitution of the film. The film thus obtained may be monoaxially or biaxially drawn, according to the known techniques for converting plastics. The sheets or plates may be cut, thermoformed or stamped in order to give them the desired shape.

The film can also be coated with the above polymers or silicone-based coatings (e.g. SiOx) or aluminum oxide or any other coating applied by plasma, web coating or electron-beam coating.

The film within the context of the invention may also be a multilayer film, having at least 2 layers formed from polymeric or other materials that are bonded together by any conventional or suitable method, including one or more of the following: coextrusion, extrusion coating, lamination, vapor deposition coating, solvent coating, emulsion coating, and/or suspension coating. At least one of the layers of the multilayer film comprises at least silicate S1.

Generally, the film is transparent and flexible.

The layer thickness of the film may be in the range from 50 μm to 1 mm, preferably from 100 μm to 800 μm, more preferably from 200 μm to 700 μm.

The film within the context of the invention may exhibit a transmission superior or equal to 80%, preferably from 85% to 98%. The transmission may be measured with a Gardner Haze-gard i (4775) Haze Meter from BYK, for instance according to the standard method ASTM D1003.

### Application

The present invention also refers to a method for increasing the fruit development of a plant by providing a greenhouse film according to the invention to a plant in a growing medium with a light treatment. The invention also refers to a method for increasing the fruit development of a plant in which the fruit development is stimulated by a light emission provided by a greenhouse film. The invention also refers to a method for increasing the fruit development of a plant in which the plant is in a greenhouse comprising a greenhouse film.

The film can form the cover of a greenhouse (roof, walls), protecting the plants from the influences of the surrounding or the film can be used in the inside of a greenhouse to cover or protect the plants or a part of the plants from influences originating from inside, such as artificial watering or spraying of herbicides and/or insecticides.

The growing media are well known agronomically suitable media in which plants may be cultivated. Examples include any of various media containing agronomically suitable components (e.g., sand, soil, vermiculite, peat); agar gel; and any of various hydroponic media, such as water, glass wools or Perlite®). Water and mineral nutrients are two inputs that are essential in any horticultural or agricultural operation, and the management of the application of these substances can have a large influence on both yield and quality. There is a large variety of different ways these two substances can be applied to satisfy plant requirements. In some embodiments, they can be applied to a soil or soilless substrates (i.e., Coco coir, peat, etc.), in which case the soil or soilless substrate absorbs water and mineral nutrients and serves as a reservoir for these substances. In other embodiments, they can also be supplied in a hydroponic system, which provides constant direct access to water and mineral nutrients by flooding, misting, dripping, wicking, or direct submersion of roots. Plant roots can either grow directly in solution, or into a substrate. If the plant is grown hydroponically in a substrate, it is referred to as “media based hydroponics.” It is typically classified as soilless production if the substrate has a high cation exchange capacity (and anion exchange capacity) and media based hydroponics when the substrate has little or no cation/anion exchange capacity. Examples of hydroponic substrates include, but are not limited to, coconut fiber, vermiculite, perlite, expanded clay pellets, and rockwool (stone wool).

Light treatment, either sun or artificial illumination may have an intensity and duration sufficient for prolonged high rates of photosynthesis throughout the growing season. Suitable illumination intensities lie between 400 and 2000 μmol/m²/s photosynthetically active radiation (400-700 nm), with direct sunlight normally providing sufficient illumination. Artificial illumination may be obtained for instance by using LED or sodium and/or mercury lamp.

A heat treatment may be applied to the plant for optimal growth, usually at a temperature comprised from 10° C. to 35° C. or higher.

As previously expressed, the fruit development notably encompasses the number of fruits produced by the plants, their sizes and/or quality, leading to an enhanced fruit yield.

Fruit development according to the present invention may be considered as at least in increase of 10% of the number of fruits produced by the plant, preferably from 10% to 80%, preferably from 15 to 50%, compared with untreated plant. This may be calculated per plant, per lot or per m² for instance.

In some embodiments the increase in fruit size comprises one or more of the following:
an increase in average fruit diameter per crop plant of at least 10%, 20%, 30%, 40%, 50%, 60%, 70%, 80%, or 90%, or between 10 to 90%, compared with an untreated crop plant;
an increase in average fruit weight per crop plant of at least 10%, 20%, 30%, 40%, 50%, 60%, 70%, 80%, or 90%, or between 10 to 90% compared with an untreated crop plant;
an increase in total fruit weight per crop plant of at least 10%, 20%, 30%, 40%, 50%, 60%, 70%, 80%, or 90%, or between 10 to 90%, compared with an untreated crop plant.

Fruit size may encompass weight, length, area, diameter, circumference or volume of a fruit.

In preferred embodiments, the increase in fruit production is a net increase of at least 10%, 20%, 30%, 40%, 50%, 75%, 85%, 95%, 100%, 150%, 200% in fruit production, corresponding to the number of fruit (total, large, or commercially valuable) per crop plant, weight of fruit (total, large, or commercially valuable) per crop plant, or total yield of fruit per crop plant, as compared to the respective values of untreated control plants.

Fruit production is generally expressed in: total kilograms of fruit per crop plant, average kilogram per fruit per crop plant, total number of fruit per crop plant, average number of fruit per crop plant, average millimeters in diameter per fruit, or in average grams per fruit.

### Experimental Part

The invention will now be further illustrated by the following non limiting examples.

### Example 1

Synthesis of Ba_{2.7}Eu_{0.3}Mg_{0.9}Mn_{0.1}Si₂O₈

Particles of Ba_{2.7}Eu_{0.3}Mg_{0.9}Mn_{0.1}Si₂O₈ (P1) are synthetized according to the process as follows:

An aqueous solution was made up from a mixture of barium, magnesium, europium and manganese nitrates with the following composition:
Ba(NO₃)₂113.51 g
Mg(NO₃)₃·6H₂O 37.11 g
Mn(NO₃)₂·4H₂O 4.00 g
Eu(NO₃)₃40.44 g

Water was added to this nitrate mixture to reach a final cationic concentration of 0.27 mol/l. A fumed silica (specific surface: 50 m²/g) suspension was also prepared with a Si concentration of 0.71 mol/l. The nitrate solution and the suspension of fumed silica were mixed to obtain a global suspension.

The suspension was dried in a flash spray dryer with and input temperature of 350° C. and an output temperature of 140° C. The dried product was calcined at 900° C. for 6 hours under air and then at 1200° C. for 6 hours under Ar/H₂ (95/5) atmosphere.

The particles have a size D₅₀ of 5.2 μm. These particles exhibit:

(a) a light emission with a first peak wavelength of 438 nm and a second peak wavelength in the range of 620 nm, and

(b) an absorption inferior to 10% at a wavelength greater than 440 nm.

### Example 2

Synthesis of Ba_{2.94}EU_{0.06} Mg_{0.95}Mn_{0.05}Si₂O₈

Particles of Ba_{2.94}EU_{0.06} Mg_{0.95}Mn_{0.05}Si₂O₈ (P2) are synthetized according to the process as follows:

A solution was made up from a mixture of barium, magnesium, europium and manganese nitrates with the following composition:
Ba(NO₃)₂ 124.60 g
Mg(NO₃)₃·6H₂O 39.49 g
Mn(NO₃)₂·4H₂O 2.01 g
Eu(NO₃)₃ 8.15 g

Water was added to this nitrate mixture to reach a final cationic concentration of 0.27 mol/l. A fumed silica (specific surface: 50 m²/g) suspension was also prepared with a Si concentration of 0.71 mol/l. The nitrate solution and the suspension of fumed silica were mixed to obtain a global suspension.

The suspension was dried in a flash spray dryer with and input temperature of 350° C. and an output temperature of 140° C. The dried product was calcined at 900° C. for 6 hours under air and then at 1200° C. for 6 hours under Ar/H₂ (95/5) atmosphere.

The particles have a size D50 of 5.2 μm.

These particles exhibit:

(a) a light emission with a first peak wavelength of 438 nm and a second peak wavelength in the range of 620 nm, and

(b) an absorption inferior to 10% at a wavelength greater than 440 nm.

### Example 3

### Production of Polymer Film

This example illustrates the use of particles of Examples 1 and 2 in a polymer film, to produce film 1 and film 2 respectively.

A masterbatch MB1 comprising 90% by weight of an ethylene/vinyl acetate copolymer (Elvax® 150, commercially available from DuPont) and 10% by weight of silicate was prepared using a co-rotating twin-screw extruder type Prism 25D (diameter 16 mm and L/D ratio of 25, screw profile 25.5)

Pellets of the ethylene/vinyl acetate copolymer and silicate S1 were premixed in a rotary mixer for 10 min and then introduced into the extruder under the following conditions :

| | |
|---|---|
| Raw material flow rate (kg/h) | 1.8 |
| Screw rotation speed (rpm) | 250 |
| Temperature (° C.) | 90 |

A masterbatch MB1 was thus obtained in the form of pellets.

To get film 1, 402 g of MB1 were mixed with 7650 g of pure ethylene/vinyl acetate copolymer (representing in the final composition a silicate loading of 0.5% by weight) during 10 minutes in a rotative blender then extruded using a co-rotating twin-screw extruder Leistritz LMM 30/34 type (34 mm diameter and L/D ratio of 25, screw profile: L16 without degassing) equipped with a slot die (300 mm in width and 450 to 500 microns thick). Extrusion parameters are reported in the following table:

| | |
|---|---|
| Raw material flow (kg/h) | 3 |
| Screw rotation speed (rpm) | 200 |
| Extrusion temperature (° C.) | 90 |
| Chill roll temperature (° C.) | 10 |
| Film output speed (m/min) | 0.5 |
| Film tension (N) | 6 |

A similar film was prepared to get film 2 by mixing 1206g of MB1 with 6848 g of pure ethylene/vinyl acetate copolymer (representing in the final composition a silicate loading of 1.5% by weight).

The obtained had a thickness of 450 μm in average.

The film 1 has a transmission of 90.6% and film 2 a transmission of 85.7% (measured with a Gardner Haze-gard i (4775) Haze Meter from BYK, according to the standard method ASTM D1003).

The film 1 obtained emits a crimson color when it is subjected to illumination at a wavelength of 365 nm.

The film 2 obtained emits a crimson color when it is subjected to illumination at a wavelength of 365 nm.

Also a film 0 without any particles is produced. The film 0 obtained does not emit any color when it is subjected to illumination at a wavelength of 365 nm.

### Example 4

### Agronomic Tests

Evaluation of the agronomic behavior of a tomato crop has been made under plastic roof in greenhouse with the use of films 1, 2 and 3.

These trials have been carried out in a special greenhouse of 20 m² of total area. This greenhouse has been divided in five different cages and a different film plastic cover has been installed in the roof of each cage. This greenhouse has been provided with an active climatic control system with a cooling system which has been controlled by an automated system, where the set point temperature and the cooling activation has been set at 26° C. The tomato crop has been grown in substrate, in coconut fibber bags. The irrigation and fertilization of the tomato crop has been carried out through the use of a drip irrigation system, with paired rows of dripper lines located at each plant, and with the emitters within the same dropper-holder branch located every 50 cm. The installation of drip irrigation has had self-compensating drippers with a unit flow of 3 liters/hour/dripper. The fertigation system used during this trial has been controlled automatically with an irrigation unit provided with a programmer and one tank of concentrated nutrient solution.

The field trial has been developed during a cropping cycle of winter-spring tomato (five months long). The tomato crop (Solanum lycopersicum variety “Trujillo”), has been transplanted in the greenhouse, with more than 20 days old since its germination in the nursery and with three leaves completely developed.

The plant density used has been 6 plants by m². During this trial, the tomato crop has been guided using black polypropylene cords vertically joined to the wire structure of the greenhouse. The total duration of the tomato cropping cycle has been 131 days.

The installation of 3 different plastic films has been carried out inside the greenhouse before the transplanting of the tomato crop. Different plastic films have been installed in the roof of each cage, so that each cage of the greenhouse has been a different experimental treatment. There have been six plants per experimental treatment (cage). The experimental treatments evaluated have been distributed inside the greenhouse following a distribution of blocks.

During all the trial period, the air temperature has been controlled continuously using a cooling system which exceeding the set point temperature of 26° C., the cooling system has been activated by emitting air from the outside to the inside of the treatments, thus allowing a renewal of the air and decreasing the air temperature.

Different parameters have been measured at seven different moments during the development of the tomato crop.

In each measurement, six tomato plants of each treatment have been evaluated. The parameter measured has been: basal diameter of the stem, length of the plant, number of developed leaves, and number of developed fruits. The pollination of the has been carried out by means of a manual system of flower vibration.

The yield harvested in each episode of fruit harvesting (during 4 fruit harvesting episodes) has been characterized by measuring the fresh weight and the number of fruits harvested in each experimental treatment, distinguishing between commercial fruits and not commercial fruits. This characterization has been carried out in each plant of a group of six plants per experimental treatment.

Results are reported in the Table 1 as follows:

TABLE 1

| PARAMETERS | DAYS | Film 0 | Film 1 | Film 2 |
|---|---|---|---|---|
| Height evolution (cm/plant) | 7 | 36.3 | 36.2 | 36.7 |
| | 32 | 75.0 | 80.0 | 79.2 |
| | 45 | 113.5 | 119.8 | 119.3 |
| | 74 | 210.8 | 208.2 | 209.8 |
| Basal diameter evolution | 7 | 0.43 | 0.5 | 0.4 |
| (cm/plant) | 32 | 0.6 | 0.6 | 0.6 |
| | 61 | 0.88 | 0.98 | 0.96 |
| | 88 | 1.12 | 1.07 | 1.14 |
| Number of leaves evolution | 7 | 5.3 | 5.5 | 5.9 |
| (#/plant) | 32 | 11.2 | 11.8 | 11.3 |
| | 74 | 15.6 | 17.0 | 16.8 |
| | 88 | 16.8 | 18.0 | 19.6 |

Table 2 shows the evolution of number of developed fruits and results of the accumulated commercial yield, expressed as accumulative values of fresh weight of harvested fruits in each episode of fruit harvesting and in each evaluated experimental treatment, of commercial fruit yield harvested during the trial. Said Table also shows the results of the accumulative values of the fresh weight of harvested fruits in each experimental treatment and each episode of fruit harvesting.

In the same way, Table 2 shows the results of the accumulated amount of fruits produced (expressed as average values of the number of fruits harvested in each episode of multiple harvests of fruit and in each experimental treatment evaluated) of commercial and total (commercial fruits+non-commercial fruits) yield of fruits obtained during the trial. Table 2 also shows the average values of the number of fruits harvested in each experimental treatment and in each episode of multiple fruit harvests made during the trial.

Accumulative commercial yield of category MMM (diameter of 40-47 mm) is also reported.

TABLE 2

| PARAMETERS | DAYS | Film 0 | Film 1 | Film 2 |
|---|---|---|---|---|
| Fruit developed evolution (#/plant) | 24 | 0.3 | 0.2 | 0.7 |
| | 88 | 23.4 | 23.8 | 24.4 |
| | 131 | 72 | 81 | 82 |
| Accumulated commercial yield (g/m²) | 88 | 142.5 | 305.0 | 395.5 |
| Accumulated number commercial fruits (#/m²) | 88 | 2 | 5 | 6 |
| | 131 | 114 | nm | 128 |
| Accumulated total yield (g/m²) | 88 | 338.0 | 361.5 | 504.0 |
| | 104 | 1159.7 | nm | 1222.0 |
| Accumulated number fruits (#/m²) | 88 | 5 | 6 | 8 |
| | 131 | 140 | 134 | 149 |
| Category of MMM commercial fruits (g/m²) | 131 | 2850 | 3984 | 3539 |
| Category of MMM commercial fruits (#/m²) | 131 | 53 | 69 | 72 |

nm = non measured

1. A film comprising at least a matrix and a silicate S1 to increase fruit development of a plant, the silicate S1 exhibiting:
(a) a light emission with a first peak wavelength in the range from 400 nm to 500 nm, and
(b) an absorption inferior or equal to 20% at a wavelength greater than 440 nm.

2. The film according to claim 1, wherein the silicate S1 is a compound of formula (I):
aMO·a′M′O·bM″O·b′M′″O·cSiO₂ (I)
wherein M and M″ are selected from the group consisting of: strontium, barium, calcium, zinc, magnesium and combinations thereof, and M′ and M′″ are selected from the group consisting of europium, manganese, praseodymium, gadolinium, and yttrium, with 0.5<a≤3, 0.5<b≤3, 0<a′≤0.5, 0<b′≤0.5 and 1≤c≤2.

3. The film according to claim 1, wherein the silicate S1 is a compound of formula (II):
aBaO·xEuO·cMgO·yMnO·eSiO₂ (II)
wherein 0<a≤3, 0<x≤0.5, 0<c≤1, 0<y≤0.5, 0<e≤2.

4. The film according to claim 3, wherein 0.0001≤x≤0.4 and 0.0001≤y≤0.4.

5. The film according to claim 3, wherein 0.01≤x≤0.35 and 0.04≤y≤0.15.

6. The film according to claim 1, wherein in formula (II) the barium, the magnesium and the silicon are not substituted with an element other than europium and manganese.

7. The film according to claim 3, wherein the compound of formula (II) is Ba_{2.7}Eu_{0.3}Mg_{0.9}Mn_{0.1}Si₂O₈.

8. The film according to claim 3, wherein the compound of formula (II) is Ba_{2.94}Eu_{0.06}Mg_{0.95}Mn_{0.05}Si₂O₈.

9. The film according to claim 1, wherein the silicate S1 is a compound of formula (III):
Ba_{3(1-x-y)}Eu₃ₓPr_{3y}Mg_{1-z}Mn_{z}Si_{2(1-3v/2)}M₃ᵥO₈ (III)
wherein M represents aluminum, gallium or boron and 0<x≤0.3; 0<y≤0,1; 0<z≤0.3; 0≤v≤[[0,1]]0.1.

10. The film according to claim 1, wherein an amount of silicate S1 in the film is from 0.01 to 10% by weight, with respect to a total amount of film.

11. The film according to claim 1, wherein the silicate S1 is in the form of solid particles having a size D50 between 1 μm and 50 μm.

12. The film according to claim 1, wherein the silicate S1 is in the form of solid particles having a size D50 between 0.1 μm and 1.0 μm.

13. The film according to claim 1, wherein the matrix comprises at least one polymer or wherein the matrix is a polymer.

14. The film according to claim 13, wherein the matrix is based on a polymer selected from the group consisting of: polyethylenes and copolymers, including low-density polyethylenes (LDPE), linear low-density polyethylenes (LLDPE), high density polyethylene (HDPE), polyethylenes obtained via metallocene synthesis, ethyl vinylacetate copolymer (EVA), ethylene butyl acrylate copolymer (EBA), polyvinyl chloride (PVC), polyethylene terephthalate (PET), polymethyl methacrylate (PMMA), (co)polyolefins, polyethylene-vinyl alcohol (EVOH), polycarbonate (PC), and mixtures and copolymers based on these (co)polymers.

15. The film according to claim 1, wherein the plants is selected from the group consisting of tomatoes, watermelons, peppers, zucchinis, cucumbers, melons, strawberries, blueberries, and raspberries.

16. (canceled)

17. (canceled)

18. A method for increasing fruit development of a plant in which the fruit development is stimulated by a light emission provided by a greenhouse film; said film comprising at least a matrix and a silicate S1, said silicate S1 exhibiting:
(a) a light emission with a first peak wavelength in the range from 400 nm to 500 nm, and
(b) an absorption inferior or equal to 20% at a wavelength greater than 440 nm.

19. A method for increasing fruit development of a plant in which the plant is in a greenhouse comprising a greenhouse film; said film comprising at least a matrix and a silicate S1, said silicate S1 exhibiting:
(a) a light emission with a first peak wavelength in the range from 400 nm to 500 nm, and
(b) an absorption inferior or equal to 20% at a wavelength greater than 440 nm.
